(19) United States
(12) Patent Application Publication
(10) Pub. No.: US 2017/0120276 A1
(43) Pub. Date: May 4, 2017

(54) Dispensing Device for Dispensing a Viscous or Liquid Product from a Reservoir, and a Receptacle Comprising Such a Dispensing Device

(71) Applicant: Albea Thomaston Inc., Wilmington, DE (US)

(72) Inventors: Herve Imenez, Feuquieres En Vimeu (FR); Christophe Desanaux, Les Essarts (FR); Jonathen Woodman, Bantam, CT (US)

(21) Appl. No.: 15/337,600

(22) Filed: Oct. 28, 2016

(30) Foreign Application Priority Data
Nov. 2, 2015 (EM) 15192641.7

(51) Int. Cl. B05B 11/00

(52) U.S. Cl. CPC B05B 11/3059; B05B 11/3001; B05B 11/3045

(57) ABSTRACT

A dispensing device dispenses a viscous or liquid product from a fluid reservoir. The dispensing device has an actuator (10), a dispensing member (12) configured to be actuated by the actuator, and a collar (14) configured to be linked to the reservoir and to support the dispensing member. The dispensing device being configured so that the actuator (10) can shift from a first position in which an actuation of the dispensing member (12) by the actuator (10) is allowed along an longitudinal axis of the dispensing device to a second position in which an actuation of the dispensing member (12) by the actuator (10) is blocked by abutting surfaces of the actuator (10) and the collar (14). One or some of the abutting surfaces and at least one reinforcement zone are provided on two opposite sides of a locking sleeve (60) of the dispensing device.

### CROSS-REFERENCE TO RELATED APPLICATIONS

This application claims priority to European application serial No. 15192641.7 filed Nov. 2, 2015 which application is hereby incorporated by reference in its entirety.

### FIELD

The present invention relates to a dispensing device for dispensing a viscous or liquid product from a reservoir. It also relates to a receptacle comprising such a dispensing device.

### BACKGROUND

In the prior art, dispensing devices are provided with an actuator and a pump mechanism, the actuator being configured to actuate the pump mechanism by moving down the actuator along an longitudinal axis of said dispensing device. To avoid an unintentional actuation of the pump mechanism, dispensing devices are also known to be provided with a mechanism which allows two different configurations: a first configuration in which the pump mechanism can be activated and a second configuration in which the actuation of the actuator is blocked.

Among such kind of dispensing devices it is particularly known dispensing devices configured to be switched from said first configuration to said second configuration by rotation around the longitudinal axis of the dispensing device. In said second configuration lugs provided on said actuator abut shoulders provided on a collar linked to the reservoir. In order to avoid to switch to easily from one configuration to the other, the shoulders are provided with angular retaining means cooperating with the lugs. Thanks to these retaining means, a user needs to exert a specific strength to have the dispensing device reaching and/or leaving its blocked configuration.

Nevertheless, if the user tries to actuate the dispensing device while it is in its blocked configuration, the part of the actuator provided with the lugs may bend and the lugs may escape from the retaining means. As a consequence the actuator may unintentionally switches for its blocked configuration to the other.

### SUMMARY

The invention aims at avoiding such drawback and propose in that view a dispensing device for dispensing a viscous or liquid product from a fluid reservoir, said dispensing device comprising an actuator, a dispensing member configured to be actuated by said actuator, a collar configured to be linked to the reservoir and to support said dispensing member, said dispensing device being configured so that the actuator can shift from a first position in which an actuation of said dispensing member by said actuator is allowed along an longitudinal axis of said dispensing device to a second position in which an actuation of said dispensing member by said actuator is blocked by abutting surfaces of said actuator and said collar, wherein one or some of said abutting surfaces and at least one reinforcement zone are provided on two opposite sides of a locking sleeve of said dispensing device.

Thanks to said reinforcement zone or zones, the sleeve is prevented from bending and the blocked configuration of the dispensing device is more securely defined.

According to different embodiments of the invention, which can be taken together or separately:
said dispensing device is configured so that said actuator can be shift from said first to said second position by rotation around said longitudinal axis,
said locking sleeve is provided on said actuator,
said locking sleeve extends longitudinally,
said reinforcement zone comprises at least one internal rib,
said internal rib is oriented longitudinally,
said internal rib is located on an internal side of said locking sleeve and said abutting surface is provided on an external side of said locking sleeve,
said internal rib extends radially from said locking sleeve,
said internal rib is integral with said locking sleeve,
said internal rib has a cross section gradually decreasing in direction of distal end of said actuator,
said device comprises at least one external rib extending from said locking sleeve, said external rib being provided with one of said abutting surfaces,
said external rib extends radially from said locking sleeve,
said external rib is integral with said locking sleeve,
said collar is provided with at least one shoulder provided with another one of the abutting surfaces,
said shoulder extends angularly,
said shoulder is angularly ended by a stop surface,
said dispensing device is provided with angular retaining means configured to block an unintentional displacement of the actuator between the two positions of said actuator,
said retaining means comprises a lug provided angularly along the shoulder,
said lug is located angularly at a distance from said stop surface to define a housing for said external rib there between,
said actuator comprises at least one orifice for dispensing said product,
said orifice enables a dispensing of the product in a direction transversal to said longitudinal direction,
said collar is configured to be reversibly fastened to the reservoir,
the dispensing member downwardly abuts on said collar.

The invention also provides a receptacle comprising a reservoir and a dispensing device as described above.

### BRIEF DESCRIPTION OF THE DRAWINGS

The invention is more fully described below with reference to the accompanying drawings which show an embodiment of the invention by way of non limiting example.

FIG. 1 is a perspective view partially showing a receptacle comprising such embodiment.

FIG. 2 is a cross longitudinal view of the receptacle of FIG. 2.

FIG. 3 is cross longitudinal view, shown in perspective, of such embodiment, in a first configuration.

FIG. 4 is a cross longitudinal view, shown in perspective, of such embodiment, in a second configuration.

FIG. 5 is a cross sectional view, shown in perspective, of such embodiment, in said first configuration.

FIG. 6 is a cross sectional view, shown in perspective, of such embodiment, in said second configuration.

FIG. 7 is a cross sectional view of such embodiment, in said first configuration.

FIG. 8 is a cross sectional view of such embodiment, in said second configuration.

FIG. 9 is a perspective view of a collar of such embodiment, shown from its upper side.

FIG. 10 is a perspective view of an actuator of such embodiment, shown from its bottom side.

### DETAILED DESCRIPTION OF EXEMPLARY ASPECTS

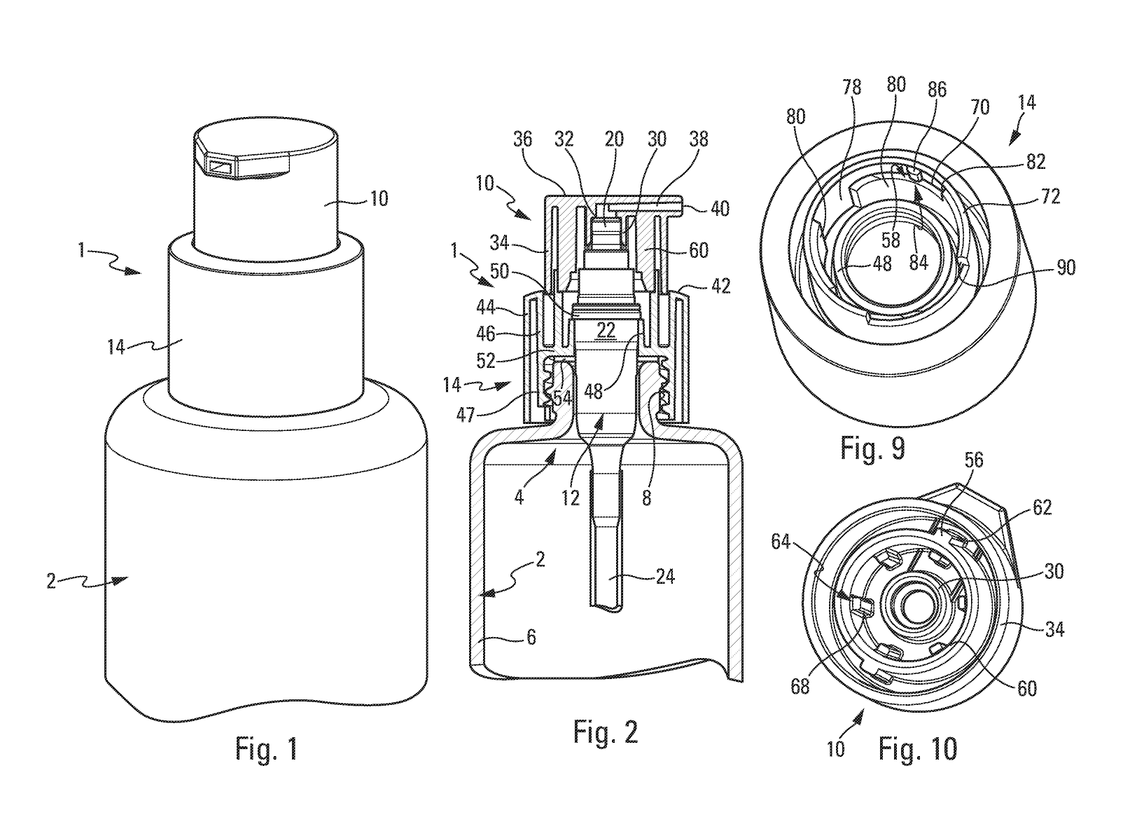

In the following description, the terms for spatial positioning are taken with reference to the position of the dispensing device as shown in the above mentioned FIGS. 1 to 4.

As illustrated in FIGS. 1 and 2, the invention relates to a dispensing device 1 for dispensing a viscous or liquid fluid stocked in a fluid reservoir 2. Said reservoir 2 may comprise a neck 4 and a body 6. The body 6 of the reservoir can be cylindrical, polygonal or any other shape. It is designed to stock the fluid. Advantageously, the dispensing device 1 is designed to be reversibly connectable to the neck 4 of said reservoir. The dispensing device 1 can be fastened, for example by screwing, on the neck 4 of said reservoir 2. In this case, an external surface 8 of the neck 4 can be threaded. The dispensing device 1 comprises an actuator 10, a dispensing member 12 configured to be actuated by said actuator 10 and a collar 14 configured to be linked to the reservoir 2 and to support said dispensing member 12.

The dispensing member 12 can be a pump mechanism or a valve mechanism. Here, the dispensing member 12 is a pump mechanism. Said pump mechanism 12 advantageously comprises an actuator rod 20, a pump body 22 and a feed tube 24. The actuator 10 and the activator rod 20 are coupled in translation along a longitudinal axis of the dispensing device, here a vertical axis, meaning that they move simultaneously in translation along such longitudinal axis, which causes an actuation of the pump mechanism and a distribution of product.

The actuator 10 has a cylindrical general shape and substantially extends along said longitudinal axis. The actuator 10 comprises a internal sleeve 30 defining a housing in which the actuator rod 20 abuts. Said internal sleeve 30 comprises a lateral wall defining a bottom opening passed through by said actuator rod 20 and an upper opening defining an thrust shoulder 32 for said actuator rod 20.

The actuator 10 may be a push button. It comprises an external sleeve 34 and a thrust side 36. Said external sleeve 34 defines an external lateral wall of said actuator 10. Said thrust side 36 is located at the upper end of the actuator 10 and configured to be actuated by a user. Said internal sleeve 30 and said external sleeve 34 both extend longitudinally and coaxially from said thrust side 36. Said thrust side 36 may be slightly incurved for reasons of ergonomics but could also be planar, as designed here, or convex.

Said thrust side 36 comprises an exit channel 38 for the product to be distributed. Said exit channel 38 is here oriented transversally to said longitudinal axis. Said exit channel 38 communicates at one end with said upper opening of said internal sleeve 30 and is provided at the other end with an orifice 40 for dispensing said product.

Said thrust side 36 can be pressed by the user in a pushing direction, said pushing direction being parallel to said longitudinal axis. By doing so the actuator rod 20 is actuated downwardly and the pump is activated. The product exits the actuator rod 20, passes through the upper opening of said internal sleeve 30, flows in said exit channel 38 and is distributed externally through said orifice 40.

The collar 14 is configured to allow the actuator 10 to slide along said longitudinal axis when presses. It comprises an upper side defining a ring 42 surrounding the external sleeve 34 of said actuator 10. The collar 14 further comprises an external sleeve 44 and an intermediate sleeve 46.

Said external and intermediates sleeves 44, 46 both extend longitudinally and concentrically from said ring 42. Said external sleeve 44 defines a lateral external wall of said collar 14. Said intermediate sleeve 46 defines in a lower part 47 a thread to engage with the thread provided on the receptacle neck 4. More generally, said collar 14 is configured to be reversibly fastened to the reservoir 2. The collar 14 further comprises an internal sleeve 48. Said internal sleeve 48 comprises an upper edge engaging with a shoulder 50 in the form of a ring provided on said pump body 22 so that the dispensing member 12 downwardly abuts on said collar 14. The pump body 22 may be fastened to the collar 4.

The collar 14 further comprises a flange 52 oriented perpendicularly to said longitudinal axis of said dispensing device. It radially extends from the intermediate sleeve 46 to a lower edge of said internal sleeve 48. A sealing gasket 54 is here provided between said flange 52 and an upper edge of said neck 4. The thread defined by said intermediate flange 46 is located between said flange 52 and a free end of said intermediate sleeve 46.

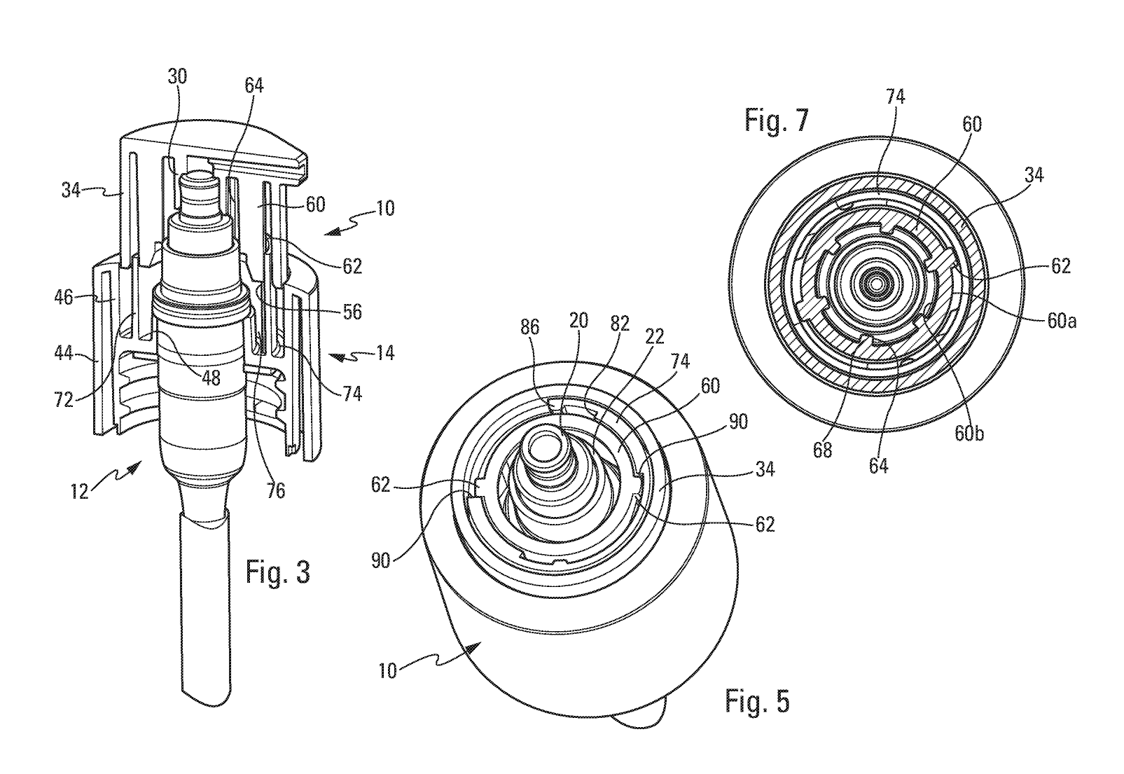

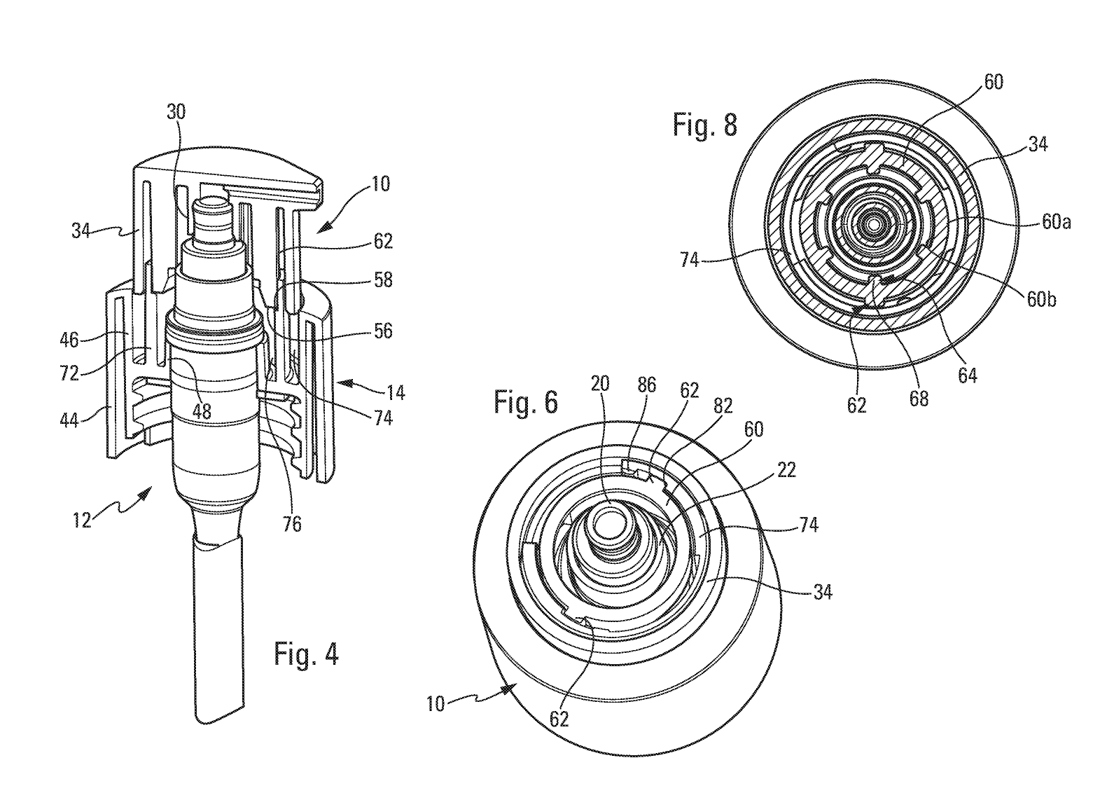

As illustrated in the FIGS. 3 to 8, said dispensing device is configured so that the actuator 10 can shift from a first position in which an actuation of said dispensing member 12 by said actuator 10 is allowed along said longitudinal axis of said dispensing device (FIGS. 3, 5 and 7) to a second position in which an actuation of said dispensing member 12 by said actuator 10 is blocked (FIGS. 4, 6 and 8) meaning that the actuator cannot be actuated anymore. Such result is obtained through abutting surfaces 56, 58 respectively provided on said actuator 10 and said collar 14 said abutting surfaces facing each other in said second position (see FIG. 4).

Said dispensing device is advantageously configured so that said actuator 10 can be shifted from said first to said second positions by rotation around said longitudinal axis.

In that view, said device comprises a locking sleeve 60 which is provided with one or more external ribs 62 extending from said locking sleeve 60, each of said external rib 62 being provided with one 56 of said abutting surfaces. The device is here provided with two external ribs 62 located at 180° from each other. Said external ribs 62 extend radially from said locking sleeve 60. They are integral with said locking sleeve 60.

According to the invention, said abutting surfaces 56 and at least one reinforcement zone 64 are respectively provided on two opposite sides 60a, 60b of said locking sleeve 60. The locking sleeve 60 is hence prevented to bend when the actuator 10 is pressed while it is in its second position. The actuator 10 can then remain locked even in case of misuse.

Said locking sleeve 60 is provided here on said actuator 10. It extends longitudinally and coaxially with the internal and external sleeves 30, 34 provided on said actuator 10. Said locking sleeve 60 extends from the thrust side 36 between said internal and external sleeves 30, 34.

Several said reinforcement zone 64, here six, may be provided. They are advantageously regularly distributed around said longitudinal axis. Said reinforcement zone 64 are here defined by internal ribs 68. They may extend radially from said locking sleeve 62. They are integral with said locking sleeve 60.

The actuator 10 may obtained by molding, especially injection molding. In order to have a simplified molding process, said internal ribs 68 are oriented longitudinally. They advantageously have a cross section gradually decreasing in direction of a distal end of said actuator 10.

Said internal ribs 68 are located on an internal side 60b of said locking sleeve 60 and said abutting surface 56 provided on said actuator 10 are located on an external side 60a of said locking sleeve 60.

Said collar 14 comprises here a further sleeve 72, called counter locking sleeve in the following. Said counter locking sleeve 72 is located coaxially between said intermediate sleeve 46 and said internal sleeve 48 of said collar 14. A external circular groove 74 and internal circular groove 76 are hence respectively defined between said intermediate sleeve 46 and said counter locking sleeve 72 of said collar 14 and between said counter locking sleeve 72 and said internal sleeve 48 of said collar 14. Said external sleeve 34 and said locking sleeve 60 of said actuator 10 longitudinally slides respectively in said external and internal grooves 74, 76 when said actuator 10 is pressed.

As can be better seen on FIG. 9, said counter locking sleeve 72 defines recesses 78 located on an internal side thereof between pads 80 corresponding to an area of increased thickness of said counter locking sleeve 72.

Said collar 14 is provided with at least one shoulder 70, for instance two shoulders 70, provided with the other abutting surfaces 58. Said shoulders 70 are here defined on an upper edge of said pad. Said shoulders 70 extend angularly between said recess 78 and a stop surface 82. In said second position said external ribs 62 of said actuator 10 engage angularly with said stop surface 82.

Advantageously, said dispensing device is provided with angular retaining means 84 configured to block an unintentional displacement of the actuator 10 between the two positions of said actuator 10. Said retaining means 84 comprises a lug 86 provided angularly along the shoulders 70. Said lug 86 extend internally in a radial direction. It is integral with said collar 14. Said lug 86 is located angularly at a distance from said stop surface 82 to define a housing for said external ribs 62 there between when said actuator is in said second position.

On an angular opposite side of the pads 80, an edge thereof may define another stop surface 90 engaging angularly with said external ribs when said actuator 10 is in said first position. As it will have been understood, in said second position, said external ribs 62 are blocked between said lugs 86 and said stop surface 82 (see especially FIGS. 6 and 8). To switch to said first position, the user turns the actuator counter clockwise along the longitudinal axis of said dispensing device to pass over said lugs 86. A further rotation of the actuator 10 leads the external ribs 62 in the recesses 78 and the actuator is free to slide longitudinally (see especially FIGS. 5 and 7). The external ribs 62 may then be guided along said another stop surface 90. In all angular positions, especially when the external ribs 62 are located between said lugs 86 and said stop surfaces 82, the internal ribs 68 prevent the locking sleeve 60 to bend.

It should also be noted that the dispensing device according to the invention is advantageously configured so that the whole assembly of its components can be done by simple axial translations.

Moreover, preferentially, the dispensing device is configured so that a disconnection of the collar 14 from the reservoir causes a disconnection of the dispensing device as a whole from said reservoir.

1. A dispensing device for dispensing a viscous or liquid product from a fluid reservoir, said dispensing device comprising an actuator, a dispensing member configured to be actuated by said actuator, a collar configured to be linked to the reservoir and to support said dispensing member, said dispensing device being configured so that the actuator can shift from a first position in which an actuation of said dispensing member by said actuator is allowed along an longitudinal axis of said dispensing device to a second position in which an actuation of said dispensing member by said actuator is blocked by abutting surfaces of said actuator and said collar, wherein one or some of said abutting surfaces and at least one reinforcement zone are provided on two opposite sides of a locking sleeve of said dispensing device.

2. The dispensing device according to claim 1, wherein said dispensing is configured so that said actuator can be shift from said first to said second positions by rotation around said longitudinal axis.

3. The dispensing device according to claim 1, wherein said locking sleeve is provided on said actuator.

4. The dispensing device according to claim 1, wherein said locking sleeve extends longitudinally.

5. The dispensing device according to claim 1, wherein said reinforcement zone comprises at least one internal rib.

6. The dispensing device according to claim 5, wherein said internal rib is located on an internal side of said locking sleeve and said abutting surface is provided on an external side of said locking sleeve.

7. The dispensing device according to claim 1, wherein said device comprises at least one external rib extending from said locking sleeve, said external rib being provided with one of said abutting surfaces.

8. The dispensing device according to claim 7, wherein said collar is provided with at least one shoulder provided with another one of the abutting surfaces.

9. The dispensing device according to claim 8, wherein said shoulder extends angularly and said shoulder is angularly ended by a stop surface.

10. The dispensing device according to claim 9, wherein said dispensing device is provided with angular retaining means configured to block an unintentional displacement of the actuator between the two positions of said actuator.

11. The dispensing device according to claim 10, wherein said retaining means comprises a lug provided angularly along the shoulder.

12. The dispensing device according to claim 11, wherein said lug is located angularly at a distance from said stop surface to define a housing for said external rib there between.

13. The dispensing device according to claim 1, wherein the actuator comprises at least one orifice for dispensing said product, said orifice enabling a dispensing of the product in a direction transversal to said longitudinal direction.

14. The dispensing device according to claim 1, wherein the dispensing member downwardly abuts on said collar.

15. Receptacle comprising a reservoir and a dispensing device according to claim 1.
